(19) United States
(12) Patent Application Publication
(10) Pub. No.: US 2021/0319444 A1
(43) Pub. Date: Oct. 14, 2021

(54) SECURE PAYMENTS BY THIRD PARTIES USING A PROCESSING PLATFORM IN LIVE ENTERTAINMENT INDUSTRIES

(71) Applicant: THE ANSCHUTZ CORPORATION, Denver, CO (US)

(72) Inventors: Kelly WILLIAMS, Ringgold, GA (US); Miranda GAMEZ, Dallas, TX (US)

(21) Appl. No.: 17/271,848

(22) PCT Filed: Aug. 27, 2019
(86) PCT No.: PCT/US2019/048291

§ 371 Date: Feb. 26, 2021

Related U.S. Application Data
(60) Provisional application No. 62/723,378, filed on Aug. 27, 2018.

(51) Int. Cl. G06Q 20/40; G06Q 20/02; G06Q 20/42; G06Q 20/04

(52) U.S. Cl. CPC G06Q 20/401; G06Q 20/02; G06Q 20/047; G06Q 20/0457; G06Q 20/42

(57) ABSTRACT

The present invention relates to secure electronic payment solutions that eliminate the manual handling of sensitive payment information, thereby eliminating the data security risk inherent in handling sensitive payment information in an insecure manner. The invention is applicable to a wide variety of use cases, including but not limited to internal ticket orders, suite rentals, and suite catering, and a wide variety of payment methods, including but not limited to credit card payment.

### CROSS REFERENCE TO RELATED APPLICATION

This application claims the benefit of U.S. Provisional Patent Application 62/723,378, filed 27 Aug. 2018, the entirety of which is incorporated herein by reference.

### FIELD OF THE INVENTION

Embodiments of the present invention relate to processing of credit card transactions where the physical credit card is not present, and more specifically to the use of a software-based document management and credit card processing platform in the sale and purchase of tickets for live entertainment and sporting events.

### BACKGROUND OF THE INVENTION

In the field of ticketing for live entertainment and sporting events, current processes for handling credit card transactions where the physical credit card is not present often are not secure (i.e. PCI-compliant) or compliant with various state laws and/or the merchant agreements of credit card payment processors such as Visa, Mastercard, and American Express. This lack of security can cause payment processors to suspend the merchant capabilities of the event or the box office and/or venue manager, may result in the levying of fines by government and/or payment processors, may result in lawsuits if lack of compliance with PCI Data Security Standards or legal requirements result in a security incident, and increases the cost of PCI compliance. In addition, insecure management of sensitive consumer payment data can impact the reputation of an event, a venue, or a venue manager, and can be extremely expensive—on average, about $4,000,000, or about $158 per record.

There is thus a need in the art for a secure software-based credit card processing platform for use in a wide variety of live entertainment and sporting event ticketing use cases, including but not limited to single ticket sales, premium seat licensing, suite rental, business meeting venue management, security deposit processing, venue rental agreements, and other types of credit card payment.

### SUMMARY OF THE INVENTION

It is one aspect of the present invention to provide a method for facilitating secure payment for the purchase of event tickets, comprising (a) receiving, by a ticket or venue manager computer or client, an event ticket request from an electronic address associated with a customer; (b) communicating, by the ticket or venue manager computer or client, a link to a secure ticket request form to the electronic address associated with the customer; (c) receiving, by a server, a completed, electronically signed secure ticket request form comprising credit card information from the electronic address associated with the customer; (d) submitting, by the server, a credit card authorization based on the credit card information; (e) charging, by the server, a credit card corresponding to the credit card information; (f) communicating, by the server, a payment authorization to the ticket or venue manager computer or client; and (g) communicating, by the server, at least one of the event tickets, a purchase confirmation, and a payment receipt to the electronic address associated with the customer.

In embodiments, the secure ticket request form may comprise at least one customer-editable field and at least one non-customer-editable field.

In embodiments, the secure ticket request form may be a secure PDF file.

In embodiments, the method may further comprise collecting, by the server, transaction information relating to the secure payment; and generating, by the server, an accounting report comprising the transaction information.

In embodiments, the electronic address associated with the customer may be an email address. In step (b), the ticket or venue manager computer or client may, but need not, communicate the link to the secure ticket request form via email. In step (g), the server may, but need not, communicate the at least one of the event tickets, the purchase confirmation, and the payment receipt via email.

It is another aspect of the present invention to provide a method for facilitating secure payment for the purchase of event tickets, comprising (a) generating, by a ticket or venue manager computer or client, an electronic communication comprising a link to a secure ticket request form; (b) communicating, by the ticket or venue manager computer or client, the electronic communication to electronic addresses associated with a plurality of targeted customers; (c) receiving, by a server, at least one completed, electronically signed secure ticket request form comprising credit card information from at least one electronic address associated with a targeted customer; (d) submitting, by the server, a credit card authorization based on the credit card information; (e) charging, by the server, a credit card corresponding to the credit card information; (f) communicating, by the server, a payment authorization to the ticket or venue manager computer or client; and (g) communicating, by the server, at least one of the event tickets, a purchase confirmation, and a payment receipt to the electronic address associated with the targeted customer.

In embodiments, the secure ticket request form may comprise at least one customer-editable field and at least one non-customer-editable field.

In embodiments, the secure ticket request form may be a secure PDF file.

In embodiments, the electronic address associated with the customer may be an email address. In step (b), the electronic communication may, but need not, be an email. In step (g), the server may, but need not, communicate the at least one of the event tickets, the purchase confirmation, and the payment receipt via email.

In embodiments, step (d) may be performed after a predetermined offer expiration deadline.

It is another aspect of the present invention to provide a method for facilitating secure payment for the purchase of event tickets, comprising (a) retrieving, by a ticket or venue manager computer or client, one of a plurality of bulk send templates of a template library, wherein the bulk send templates are encoded and stored as data structures in a computer memory; (b) initiating, based on the retrieved bulk send template, a bulk send process having an offer expiration deadline; (c) retrieving, by a server, first seat information and first seat holder information from a seat holder master spreadsheet, wherein the seat holder master spreadsheet is encoded and stored as at least one data structure in a computer memory; (d) generating, by the server, a plurality of customer-specific electronic communications, each customer-specific electronic communication comprising a link to an individualized secure ticket request form; (e) sending, by the server, the plurality of customer-specific electronic communications to electronic addresses associated with each of a plurality of customers; (f) receiving, by the server, at least one electronically signed secure ticket request form comprising credit card information from at least one electronic address associated with a customer; (g) submitting, by the server, a credit card authorization based on the credit card information; (h) retrieving, by the server, second seat information and second seat holder information from a seat holder database, wherein the seat holder database is encoded and stored as at least one data structure in a computer memory; (i) charging, by the server, a credit card corresponding to the credit card information; (j) communicating, by the server, a payment authorization to the ticket or venue manager computer or client; and (k) communicating, by the server, at least one of the event tickets, a purchase confirmation, and a payment receipt to the electronic address associated with the customer.

In embodiments, the secure ticket request form may comprise at least one customer-editable field and at least one non-customer-editable field.

In embodiments, the secure ticket request form may be a secure PDF file.

In embodiments, the electronic address associated with the customer may be an email address. The customer-specific electronic communications may, but need not, be emails. In step (k), the server may, but need not, communicate the at least one of the event tickets, the purchase confirmation, and the payment receipt via email.

To comply with written description and enablement requirements, the following references are incorporated herein for their disclosures of particular devices and methods that can be employed in various embodiments of the present invention:

U.S. Patent Application Publication 2012/0116959, entitled “Transactional services,” published 10 May 2012 to Pitroda et al. (“Pitroda I”).

U.S. Patent Application Publication 2016/0119332, entitled “Direct user to ticketing service provider secure transaction channel,” published 28 Apr. 2016 to Pitroda et al. (“Pitroda II”).

U.S. Pat. No. 9,712,521, entitled “Dynamic secure login authentication,” published 18 Jul. 2017 to Vargas et al. (“Vargas”).

U.S. Patent Application Publication 2018/0130053, entitled “Reducing cybersecurity risks when purchasing products over a network,” published 10 May 2018 to Matthews et al. (“Matthews”).

U.S. Patent Application Publication 2018/0181939, entitled “Fraud detection in portable payment readers,” published 28 Jun. 2018 to Hamilton et al. (“Hamilton”).

U.S. Patent Application Publication 2018/0211258, entitled “System and method for secure personal information retrieval,” published 26 Jul. 2018 to Buis et al. (“Buis”).

U.S. Patent Application Publication 2018/0218358, entitled “Trusted service manager (TSM) architectures and methods,” published 2 Aug. 2018 to Mardikar (“Mardikar”).

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a simplified workflow diagram of a method for using a software-based credit card processing platform in the sale and purchase of tickets for live entertainment and sporting events, according to embodiments of the present invention.

FIG. 4 is a detailed workflow diagram of a prior art method for processing credit card transactions in the sale of tickets for live entertainment and sporting events to an individual customer.

FIG. 5 is a detailed workflow diagram of a method for processing credit card transactions in the sale of tickets for live entertainment and sporting events to an individual customer, according to embodiments of the present invention.

FIG. 6 is a detailed workflow diagram of a prior art method for processing credit card transactions in the bulk sale of tickets for live entertainment and sporting events.

FIG. 7 is a detailed workflow diagram of a first embodiment of a method for processing credit card transactions in the bulk sale of tickets for live entertainment and sporting events, according to the present invention.

FIG. 8 is a detailed workflow diagram of a second embodiment of a method for processing credit card transactions in the bulk sale of tickets for live entertainment and sporting events, according to the present invention.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

The term “electronic address,” as used herein, may include any identifying information associated with a specific computer or client, or a user thereof. Examples of “electronic addresses” as that term is used herein include, without limitation, email addresses, IP addresses, and telephone numbers (e.g. for electronic communication via SMS messaging).

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future- developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. In additional embodiments, the disclosed methods may be implemented in conjunction with functional programming. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

It is to be expressly understood that, although the following examples and embodiments are shown and described with reference to live entertainment and sporting events/venues and ticketing therefor, embodiments of the present invention may also be applicable to contracts for catering, suite rental, merchandise, and the like.

It is to be further expressly understood that, although the following examples and embodiments are shown and described with reference to payments via credit card, embodiments of the present invention may also be applicable to secure payments via any suitable e-commerce payment method and/or platform, including but not limited to electronic bank payments (e.g. via electronic funds transfer and/or Internet banking), PayPal, Paytm, MovoCash, Paymentwall, Google Wallet, mobile money wallets, online wallets (e.g. AliPay, ApplePay, eWallet, GooglePay, Gyft, Venmo, WeChat, etc.), Braintree, Stripe, wire transfer, mobile carrier billing (e.g. SMS- or USSD-based transactional payments, mobile web payments, direct operator billing), contactless near-field communication (NFC) payments, QR code payments, cloud-based mobile payments, audio signal-based payments, direct carrier/bank mobile payments (e.g. T-Cash), mobile bank transfer systems, payment via cryptocurrency, and the like.

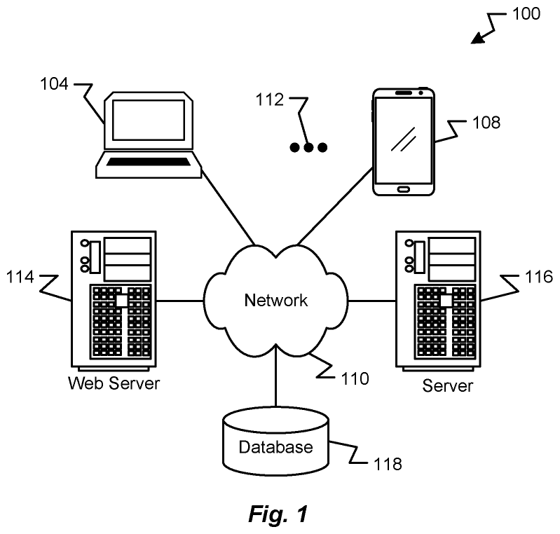

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114, which may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116.

Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

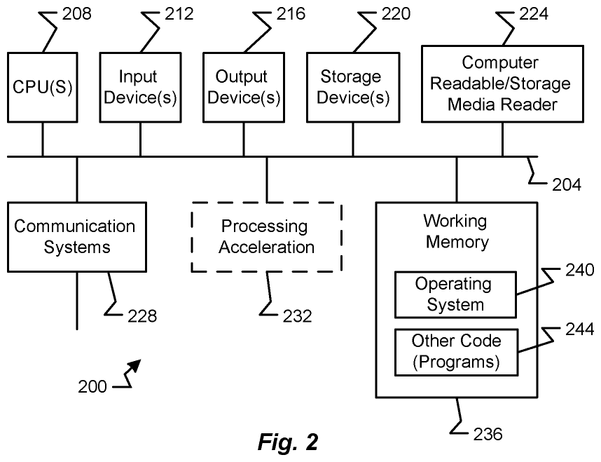

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future- developed standard, instruction set, libraries, and/or architecture.

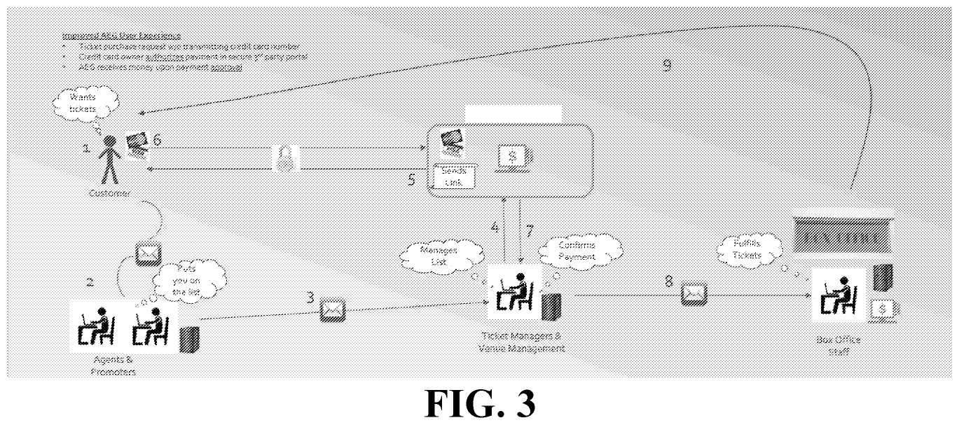

Referring now to FIG. 3, a simplified workflow diagram of a method for using a software-based credit card processing platform in the sale and purchase of tickets for live entertainment and sporting events, according to embodiments of the present invention, is illustrated. In the method illustrated in FIG. 3, a customer computer 1 communicates to an entertainment agent or promoter computer 2, by means that may include but are not limited to email, the customer's desire to purchase tickets for a live entertainment or sporting event. The agent or promoter computer 2 then communicates to a ticket or venue manager computer 3, by means that may include but are not limited to email and/or SMS, identifying information associated with the customer, such that the ticket or venue manager computer 3 may place the identifying information on a customer list, e.g. by encoding the identifying information as a data structure and storing the data structure in a computer memory; the identifying information typically includes an email address or other information necessary to communicate with the customer computer 1 electronically. The ticket or venue manager computer 3 then sends a command 4 containing the identifying information associated with the customer to a server operating a software platform. The server and/or software platform, in turn, creates a secure payment portal or document unique to the customer, for example a secure web-fillable PDF, and sends a communication 5 containing a link to the secure payment portal or document to the customer computer 1, by means that may include but are not limited to email. The customer may then, via one or more user input devices of the customer computer 1, activate the link and input payment information 6 into the secure payment portal or document, whereupon the customer computer 1 transmits the payment information 6 back to the server operating the software platform. The server and/or software platform then notifies the ticket or venue manager computer 3 that payment information has been received, such that the ticket manager may confirm and/or verify that the payment has been successful (without necessarily being able to directly view the payment information 6), whereupon the ticket or venue manager computer 3 communicates, by means that may include but are not limited to email, a payment confirmation 8 to a box office, which fulfills tickets 9 and provides the tickets to the customer 1.

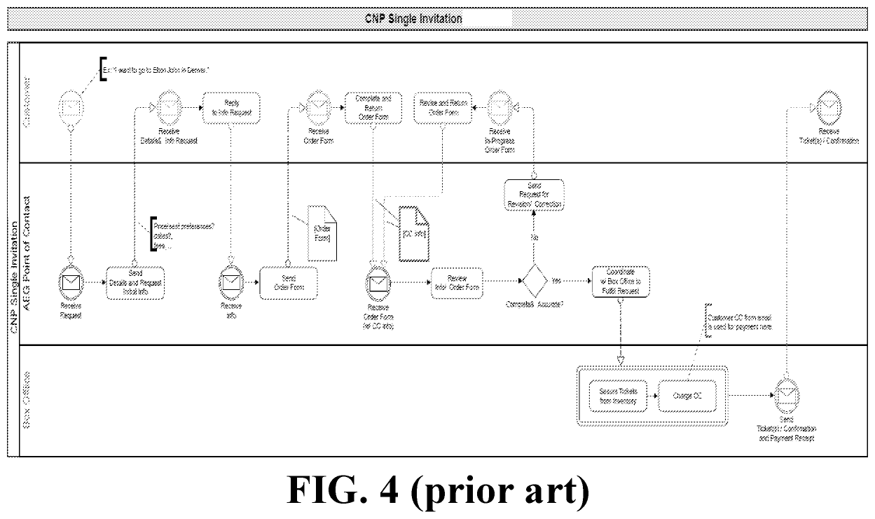

Referring now to FIG. 4, a detailed workflow diagram of a prior art method for processing credit card transactions in the sale of tickets for live entertainment and sporting events to an individual customer is illustrated. In the prior art method illustrated in FIG. 4, a customer emails a ticket or venue manager to request tickets for a particular live entertainment or sporting event. The ticket or venue manager receives the request and emails the customer to communicate details of the live entertainment or sporting event and request initial information from the customer, e.g. price and seat preferences, etc. The customer receives the details and information request and replies to the ticket or venue manager with the requested initial information. The ticket or venue manager receives the initial information and emails an order form to the customer. The customer receives the order form, completes it by filling in credit card information inter alia, and returns the completed order form to the ticket or venue manager. The ticket or venue manager reviews the completed order form to ensure that it is accurate, and, if the completed order form is not accurate, emails a request for revision and/or correction to the customer, who must then revise the in-progress order form and return the form, which again contains credit card information, to the ticket or venue manager; this cycle is repeated until all necessary information on the order form is complete and accurate. Once the ticket or venue manager has ensured a complete and accurate order form, the ticket or venue manager then communicates the order form to a box office, which secures the desired tickets from inventory and, using the credit card information provided by the customer via email, charges the customer's credit card to fulfill payment. The box office then emails one or more of tickets, a purchase confirmation, and a payment receipt to the customer. As will be apparent to those of skill in the art, the prior art method illustrated in FIG. 4 is not only badly insecure, necessitating the communication of sensitive payment information by insecure methods such as email, but also time-consuming and potentially frustrating, as it requires multiple rounds of communication at least between the customer and the ticket or venue manager.

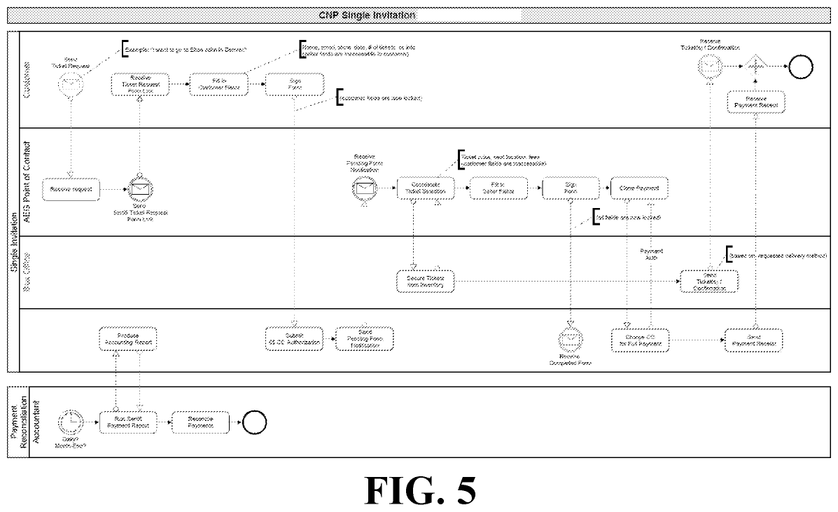

Referring now to FIG. 5, a detailed workflow diagram of a method for processing credit card transactions in the sale of tickets for live entertainment and sporting events to an individual customer, according to embodiments of the present invention, is illustrated. In the method illustrated in FIG. 5, a customer communicates, e.g. via email, a request for tickets to a particular live entertainment or sporting event to a ticket or venue manager computer. The ticket or venue manager computer receives the request and sends to an electronic address associated with the customer, e.g. via email, a link to a secure ticket request form; the secure ticket request form may contain some fields that the customer may edit and some fields that the customer may not edit, and may, but need not, take the form of, e.g., a secure PDF. Upon receipt by the customer of the link to the secure ticket request form, the customer may, via one or more user input devices of a computer associated with the customer, fill in the customer-editable fields (e.g. name, email address, event date, number of tickets desired, and credit card information) and electronically sign the form. After the customer electronically signs the secure ticket request form, the computer associated with the customer transmits the data contained in the form to a server operating a software platform, which submits a credit card authorization based on the credit card information provided in the secure form and sends a pending form notification to the ticket or venue manager computer. Upon receiving the pending form notification, the ticket or venue manager computer communicates with a box office computer, which secures appropriate tickets from an inventory; the ticket or venue manager then fills in seller-editable fields in the secure ticket request form and electronically signs the form. After the ticket or venue manager electronically signs the secure ticket request form, the ticket or venue manager computer transmits the data contained in the form to the server operating the software platform, and the ticket or venue manager computer may close payment and submit a request to charge the customer's credit card to the server operating the software platform, which in turn charges the customer's credit card and communicates a payment authorization to the ticket or venue manager computer. Once payment has closed, the box office fulfills the customer's request by delivering tickets and/or a purchase confirmation to the customer by a method specified by the customer, and the server and/or software platform sends a payment receipt to the electronic address associated with the customer. The server and/or software platform collects information relating to each transaction accomplished by this method and produces accounting reports, either automatically at appropriate intervals (e.g. daily, weekly, or monthly) or in response to a report request from an accountant or other person responsible for payment reconciliation. As will be apparent to those of skill in the art, the method illustrated in FIG. 5 is much more secure than the prior art method illustrated in FIG. 4 and significantly cuts down on the need for “back and forth” emails or other communications between the customer and the ticket or venue manager.

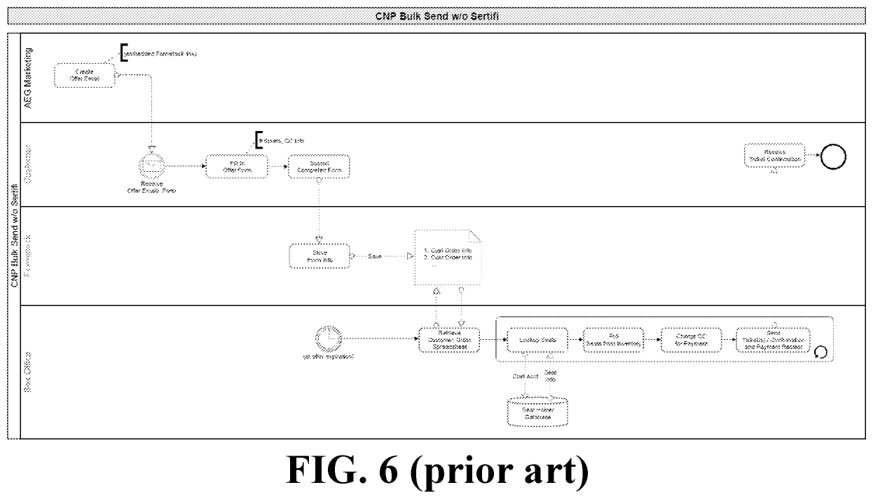

Referring now to FIG. 6, a detailed workflow diagram of a prior art method for processing credit card transactions in the bulk sale of tickets for live entertainment and sporting events is illustrated. In the prior art method illustrated in FIG. 6, an offer email containing a ticket offer form or a link thereto is created and then disseminated to a plurality of customers. Each customer who wishes to buy tickets as a result of the offer fills in the offer form with ticket purchase information, including inter alia credit card information and the number and type of tickets desired, and submits the completed order form to a server operating a software platform through an email address and/or a web interface. The server and/or software platform stores information collected from offer forms submitted by all customers who wish to buy tickets and creates, either automatically or upon a command from a box office, a customer order spreadsheet containing customer information, including credit card information. After a predetermined period, e.g. the ticket offer has expired, the box office retrieves the customer order spreadsheet. Then the box office must iterate the following process with respect to each buyer: 1) determine whether appropriate tickets are available for the desired event (including, in some cases, looking up in a database or spreadsheet of seat license/season ticket holders whether an appropriate license or ticket holder has elected to sell or forgo his or her tickets to the event in question), 2) removing the tickets from inventory, 3) charging the customer's credit card, and 4) sending one or more of tickets, a purchase confirmation, and a payment receipt to the customer. As will be apparent to those of skill in the art, the prior art method illustrated in FIG. 6 is not only badly insecure, necessitating the communication of sensitive payment information by insecure methods such as email and/or the storage of sensitive payment information in an insecure medium, but also time-consuming and potentially frustrating for box office staff, who must manually and repeatedly cross-check a list of buyers against a separate database of ticket and license holders who wish to sell or forgo their tickets.

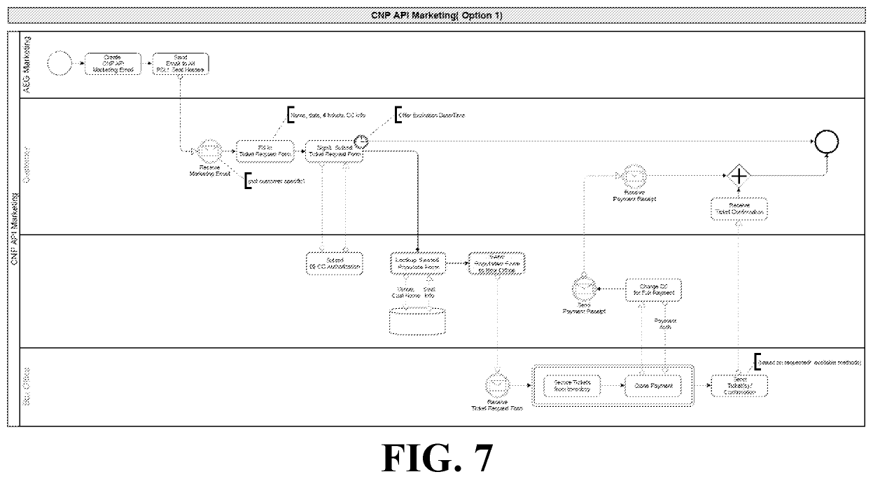

Referring now to FIG. 7, a detailed workflow diagram of a first embodiment of a method for processing credit card transactions in the bulk sale of tickets for live entertainment and sporting events, according to the present invention, is illustrated. In the embodiment illustrated in FIG. 7, a marketing email or other form of electronic communication containing a link to a secure ticket request form is created and disseminated, from a server via a network, to electronic addresses associated with a plurality of targeted customers, in this case seat license and/or season ticket holders; the secure ticket request form may contain some fields that the customer may edit and some fields that the customer may not edit, and may, but need not, take the form of, e.g., a secure PDF. Each customer who receives the link to the secure ticket request form and wishes to buy tickets may, via one or more user input devices of a computer associated with that customer, fills in the customer-editable fields (e.g. name, email address, event date, number of tickets desired, and credit card information) and electronically sign the form. After the customer electronically signs the secure ticket request form, the computer associated with that customer transmits the data contained in the form to a server operating a software platform, which, for each customer who wishes to buy tickets, submits a credit card authorization based on the credit card information provided in the secure form by the customer. After a predetermined period, e.g. after the ticket offer has expired, the server and/or software platform sends all completed ticket request forms to a box office computer, which secures all relevant tickets from inventory and closes each credit card transaction by submitting a request to charge each customer's credit card to the server operating the software platform, which in turn charges each customer's credit card and communicates a payment authorization for each transaction to the box office computer. Once payment has closed, the box office fulfills the customer's request by delivering tickets and/or a purchase confirmation to the customer by a method specified by the customer, and the server and/or software platform sends a payment receipt to the electronic address associated with the customer. As will be apparent to those of skill in the art, this embodiment is suitable for, among other use cases, sale of tickets to seat license holders, season ticket holders, preferred customers with “first refusal” rights to event tickets, and so on, e.g. before tickets for the event are sold to the general public, without requiring box office staff to manually and repeatedly cross-check a list of buyers against a separate database of ticket and license holders.

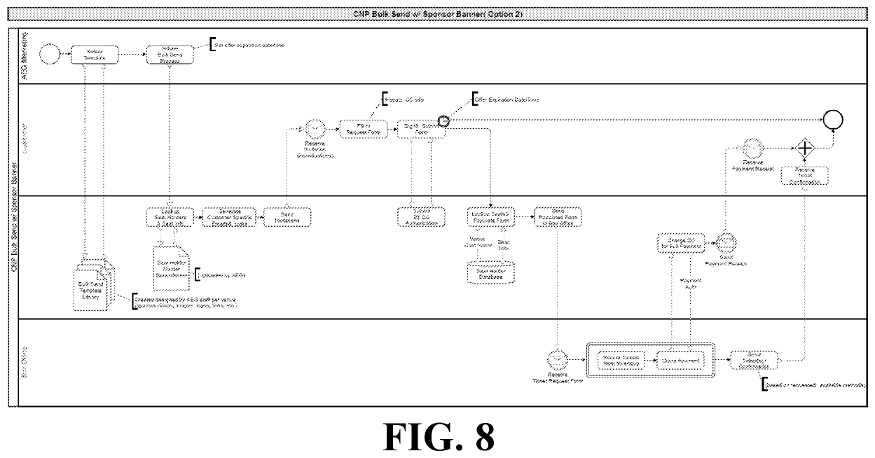

Referring now to FIG. 8, a detailed workflow diagram of a second embodiment of a method for processing credit card transactions in the bulk sale of tickets for live entertainment and sporting events, according to the present invention, is illustrated. In the embodiment illustrated in FIG. 8, one of a plurality of bulk send templates stored in a template library of a server and/or software platform, e.g. a template library stored in a computer memory associated with and accessible by the server and/or software platform, is used to initiate a bulk send process having an offer expiration deadline. Once the bulk send process is initiated, the server and/or software platform automatically looks up seat information and information pertaining to seat license/season ticket holders in a seat holder master spreadsheet stored in a computer memory associated with the server and/or software platform, generates customer-specific electronic communications (e.g. emails) and links to individualized secure ticket request forms, and sends individualized electronic invitations (e.g. emails) to an electronic address associated with each of a plurality of customers; each of the individualized secure ticket request forms may contain some fields that the customer may edit and some fields that the customer may not edit, and may, but need not, take the form of, e.g., a secure PDF. Each customer who receives the link to the secure ticket request form and wishes to buy tickets may, via one or more user input devices of a computer associated with that customer, fill in the customer-editable fields (e.g. name, email address, event date, number of tickets desired, and credit card information) and electronically sign the form. After the customer electronically signs the secure ticket request form, the computer associated with that customer transmits the data contained in the form to the server and/or software platform, which, for each customer who wishes to buy tickets, submits a credit card authorization based on the credit card information provided in the secure form by the customer. After a predetermined period, e.g. after the ticket offer has expired, the server and/or software platform automatically looks up seat and seat license/season ticket holder information in a seat holder database stored in a computer memory and populates other fields in the secure ticket request forms accordingly, then sends all completed ticket request forms to a box office computer, which secures all relevant tickets from inventory and closes each credit card transaction by submitting a request to charge each customer's credit card to the server and/or software platform, which in turn charges each customer's credit card and communicates a payment authorization for each transaction to the box office computer. Once payment has closed, the box office fulfills the customer's request by delivering tickets and/or a purchase confirmation to the customer by a method specified by the customer, and the server and/or software platform sends a payment receipt to the customer. As will be apparent to those of skill in the art, this embodiment is suitable for, among other use cases, sale of tickets to seat license holders, season ticket holders, preferred customers with “first refusal” rights to event tickets, and so on, e.g. before tickets for the event are sold to the general public, without requiring box office staff to manually and repeatedly cross-check a list of buyers against a separate database of ticket and license holders.

It is to be expressly understood that, in various embodiments of the present invention, electronic communications by and between customers (and computers and/or clients associated therewith), ticket or event manager computers and/or clients, and/or servers may take any suitable form and may be communicated by any suitable means. It is expressly contemplated that such forms and means include, but are not limited to, email, inputs into a graphical user interface (GUI) of a web interface accessed by a web browser, SMS messaging, and the like. Electronic communications of the present invention may, but need not, be transmitted via the Internet and/or a wireless telephone network.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method for facilitating secure payment for the purchase of event tickets, comprising:
(a) receiving, by a ticket or venue manager computer or client, an event ticket request from an electronic address associated with a customer;
(b) communicating, by the ticket or venue manager computer or client, a link to a secure ticket request form to the electronic address associated with the customer;
(c) receiving, by a server, a completed, electronically signed secure ticket request form comprising credit card information from the electronic address associated with the customer;
(d) submitting, by the server, a credit card authorization based on the credit card information;
(e) charging, by the server, a credit card corresponding to the credit card information;
(f) communicating, by the server, a payment authorization to the ticket or venue manager computer or client; and
(g) communicating, by the server, at least one of the event tickets, a purchase confirmation, and a payment receipt to the electronic address associated with the customer.

2. The method of claim 1, wherein the secure ticket request form comprises at least one customer-editable field and at least one non-customer-editable field.

3. The method of claim 1, wherein the secure ticket request form is a secure PDF file.

4. The method of claim 1, further comprising:
collecting, by the server, transaction information relating to the secure payment; and
generating, by the server, an accounting report comprising the transaction information.

5. The method of claim 1, wherein the electronic address associated with the customer is an email address.

6. The method of claim 5, wherein, in step (b), the ticket or venue manager computer or client communicates the link to the secure ticket request form via email.

7. The method of claim 5, wherein, in step (g), the server communicates the at least one of the event tickets, the purchase confirmation, and the payment receipt via email.

8. A method for facilitating secure payment for the purchase of event tickets, comprising:
(a) generating, by a ticket or venue manager computer or client, an electronic communication comprising a link to a secure ticket request form;
(b) communicating, by the ticket or venue manager computer or client, the electronic communication to electronic addresses associated with a plurality of targeted customers;
(c) receiving, by a server, at least one completed, electronically signed secure ticket request form comprising credit card information from at least one electronic address associated with a targeted customer;
(d) submitting, by the server, a credit card authorization based on the credit card information;
(e) charging, by the server, a credit card corresponding to the credit card information;
(f) communicating, by the server, a payment authorization to the ticket or venue manager computer or client; and
(g) communicating, by the server, at least one of the event tickets, a purchase confirmation, and a payment receipt to the electronic address associated with the targeted customer.

9. The method of claim 8, wherein the secure ticket request form comprises at least one customer-editable field and at least one non-customer-editable field.

10. The method of claim 8, wherein the secure ticket request form is a secure PDF file.

11. The method of claim 8, wherein the electronic address associated with the customer is an email address.

12. The method of claim 11, wherein, in step (b), the electronic communication is an email.

13. The method of claim 11, wherein, in step (g), the server communicates the at least one of the event tickets, the purchase confirmation, and the payment receipt via email.

14. The method of claim 8, wherein step (d) is performed after a predetermined offer expiration deadline.

15. A method for facilitating secure payment for the purchase of event tickets, comprising:
(a) retrieving, by a ticket or venue manager computer or client, one of a plurality of bulk send templates of a template library, wherein the bulk send templates are encoded and stored as data structures in a computer memory;
(b) initiating, based on the retrieved bulk send template, a bulk send process having an offer expiration deadline;
(c) retrieving, by a server, first seat information and first seat holder information from a seat holder master spreadsheet, wherein the seat holder master spreadsheet is encoded and stored as at least one data structure in a computer memory;
(d) generating, by the server, a plurality of customer-specific electronic communications, each customer-specific electronic communication comprising a link to an individualized secure ticket request form;
(e) sending, by the server, the plurality of customer-specific electronic communications to electronic addresses associated with each of a plurality of customers;
(f) receiving, by the server, at least one electronically signed secure ticket request form comprising credit card information from at least one electronic address associated with a customer;
(g) submitting, by the server, a credit card authorization based on the credit card information;
(h) retrieving, by the server, second seat information and second seat holder information from a seat holder database, wherein the seat holder database is encoded and stored as at least one data structure in a computer memory;
(i) charging, by the server, a credit card corresponding to the credit card information;
(j) communicating, by the server, a payment authorization to the ticket or venue manager computer or client; and
(k) communicating, by the server, at least one of the event tickets, a purchase confirmation, and a payment receipt to the electronic address associated with the customer.

16. The method of claim 15, wherein the secure ticket request form comprises at least one customer-editable field and at least one non-customer-editable field.

17. The method of claim 15, wherein the secure ticket request form is a secure PDF file.

18. The method of claim 15, wherein the electronic address associated with the customer is an email address.

19. The method of claim 18, wherein the customer-specific electronic communications are emails.

20. The method of claim 18, wherein, in step (k), the server communicates the at least one of the event tickets, the purchase confirmation, and the payment receipt via email.
